(19) United States
(12) Patent Application Publication
(10) Pub. No.: US 2012/0171477 A1
(43) Pub. Date: Jul. 5, 2012

(54) METHOD OF FABRICATING A COMPOSITE STRUCTURE WITH A CONDUCTIVE SURFACE

(75) Inventors: Junjie Jeffrey Sang, Newark, DE (US); Dalip Kumar Kohli, Churchville, MD (US)

(73) Assignee: CYTEC TECHNOLOGY CORP., Wilmington, DE (US)

(21) Appl. No.: 13/324,049

(22) Filed: Dec. 13, 2011

Related U.S. Application Data
(60) Provisional application No. 61/428,858, filed on Dec. 31, 2010.

(51) Int. Cl. B32B 27/04; H01B 13/00; B32B 5/02

(52) U.S. Cl. 428/339; 428/221; 156/47

(57) ABSTRACT

A method of fabricating a composite structure having a conductive surface is disclosed herein. The composite structure is formed by laminating a self-surfacing, conductive prepreg to one or prepreg plies or tapes to form a layup. The self-surfacing, conductive prepreg comprises a conductive surfacing film with a conductivity of less than 20 milliOhms formed on at least one surface of a prepreg ply or tape. Furthermore, the self-surfacing, conductive prepreg is suitable for use in an Automated Fiber Placement (AFP) process.

### CROSS-REFERENCE TO RELATED APPLICATION

This application claims benefit of priority from U.S. Provisional Application No. 61/428,858 filed Dec. 31, 2010, which is incorporated by reference herein in its entirety.

### BACKGROUND OF INVENTION

Materials used in the fabrication of component parts in the aerospace industry must have certain characteristics to protect the parts from damage or hazards caused by common environmental occurrences, in particular, electromagnetic energy (EME) events. Lightning strikes (LS), an example of a common environmental occurrence, can severely damage and/or punch through component parts if such parts are not adequately conductive and grounded throughout the aircraft. If lightning strikes a wing component of an aircraft during flight, the event has the potential of causing a dangerous surge current in addition to causing serious physical damage of the component itself. The surge current is particularly concerning because it may eventually come into contact with a fuel reservoir causing an explosion to occur. As a result of an actual fatal plane crash caused by a lightning strike, the Federal Aviation Administration (FAA) implemented a system to categorize various zones for commercial aircraft based on probability and severity of being struck by lightning. Thus, it is crucial that such component parts are manufactured to have characteristics which, among other characteristics, prevent or alleviate damage caused by lightning strikes.

Electromagnetic interference (EMI) is another electrical concern of composite parts in the aerospace industry. EMI waves consist of electric and magnetic fields which can induce electrical transients to induce excessive energy levels in the electrical wiring and probes of the fuel system. A method to prevent and/or reduce these occurrences is to add shielding materials to absorb or reflect the impinging radiation. Without proper shielding from these events, the waves can interfere with an aircraft's electronic and avionic equipment operation or even lead to ignition of fuel tanks. Absorption losses have been shown to be proportional to the thickness, conductivity and permeability of the shield material. Conventional shielding methods include housings made from cast and sheet metal, and plastics with conductive fillers or coatings.

Electrostatic discharge (ESD) is yet another concern for composite parts in the aerospace industry. ESD is the sudden and momentary electric current that flows between two objects at different electrical potentials caused by direct contact or induced by an electrostatic field. Non-conductive materials, paints, plastics have insulating properties and therefore are subject to accumulation of static charges. The resulting charges must be controlled to protect aircraft electronics and fuel tanks. Conventional ESD methods include adding fibers which have static elimination characteristics to a material, e.g., carbon fiber, or adding wicks and/or rods at the tips of aircraft components.

Static charge is imparted to a material through friction. An airplane becomes charged simply by passing through the air. Flight through precipitation (clouds or rain) increases charge accumulation, as there is more material contact. Static charge is routinely discharged in air at sea level, which is slightly conductive, and also in air with higher humidity. However, air with humidity below 20 percent and/or at higher altitudes is a poor conductor. The latter permits static charge to build up on aircraft surfaces, especially those of composite aircraft, where charge does not readily move. The build-up of charge on a structure creates a voltage potential that increases with the amount of charge. On metal structures, this voltage potential is the same everywhere because metal conducts electricity evenly. On composite structures, however, the voltage will vary. This voltage potential, in turn, generates an electric field which is most intense at areas of acute curvature such as wing tips, propeller tips, trailing edges, tips and edges of jet engine blades, etc. Built-up charge wants to travel—like charges repel and unlike charges attract. Eventually, the difference in charge between the air and structure becomes so great that the need to discharge the voltage potential takes over, resulting in a mass “dumping” of the excess charge into the atmosphere. Static charge build-up can trigger lightning within clouds or in charged atmospheric conditions.

In addition to having EME event resistant characteristics, such component parts must be manufactured to target certain weight requirements in order for the aircraft to achieve designed distance and also to overcome the gravitational force of its own weight to gain flight without using an inordinate amount of fuel. Thus, concerns of damage tolerance and resistance to common environmental occurrences while maintaining a practicable weight of these component parts must be evaluated very carefully in the manufacturing process of such parts. Damage tolerance and resistance to environmental occurrences, however, are not the only factors to be taken into consideration.

Surfacing films are used to fill and cover surface defects such as pinholes, surface cracks, core mark-off and other imperfections with the goal of reducing the cost associated with preparing composite surfaces for painting. Epoxy-based surfacing films, however exhibit poor resistance to EME events due to their insulative properties. The relatively high resistivity exhibited by epoxies inhibits the energy of a lightning strike from dissipating adequately, resulting in skin puncture and delamination of the underlying composite structure. Furthermore, the charge generated on the surface of the composite can remain for long time periods, elevating the risk of ESD in low relative humidity environments that can damage electronic systems and risk sparking in the vapor space of fuel tanks. Additionally, the poor electrical conductivity of epoxy-based surfacing films may inhibit the mobility of charge carriers, which can impair the ability of the composite structure to provide EMI shielding.

Various methods are used to address the concerns previously outlined in the manufacturing process of composite structures. For example, a conventional method for imparting lightning strike protection to component parts in the aerospace industry is the use of expanded aluminum, copper, titanium or bronze mesh, screen or foils, or interwoven wire fabrics (IWWF), incorporated into the composite part. Although such meshes are generally effective as lightning strike protection, many of these expanded mesh/screens are difficult to handle for both production and repairs.

Additionally, surfacing film systems with embedded metal screens (e.g., copper or aluminum, with fiberglass isolation layer) significantly increase the overall weight of the aircraft. Furthermore, integrating these surfacing film systems into composite materials may significantly increase the materials and labor costs for the manufacture of the composite parts. Additionally, it may be difficult to interconnect these surfacing films in a manner that achieves substantially uniform conductivity across many surfacing films, resulting in conductivity discontinuities that may result in enhanced likelihood of damage during LS or ESD and/or impaired EMI shielding. In particular, metallic screens are further subject to corrosion, thermal expansion mismatch with the matrix that leads to micro-cracking, and impaired bonding with the matrix, each of which may further diminish the LS/ESD/EMI protection afforded by the surfacing film.

### BRIEF DESCRIPTION OF THE DRAWINGS

FIGS. 1A-1B are SEM photographs of composite structures manufactured using self-surfacing, conductive prepregs according to embodiments of the invention (fracture and polished).

FIGS. 2A-2D are photographs of composite structures manufactured using self-surfacing, conductive prepregs according to embodiments of the invention subjected to lightning strike simulations.

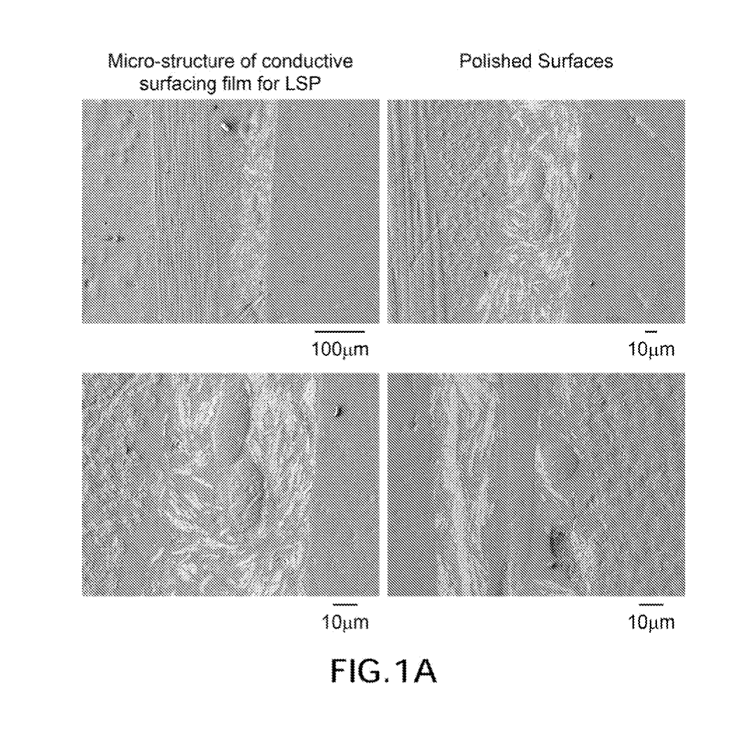

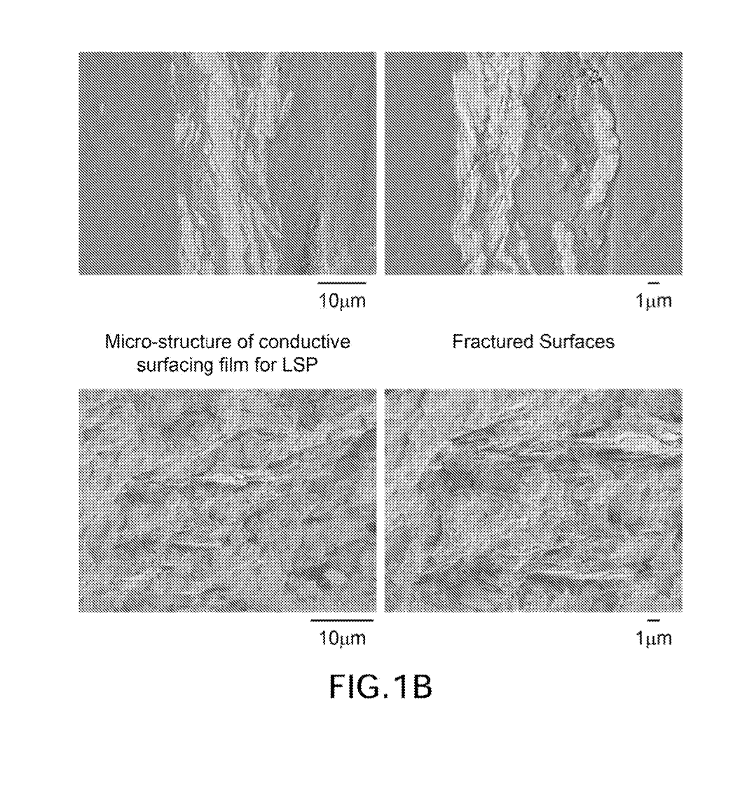

### DETAILED DESCRIPTION

The following detailed description is of the best currently contemplated modes of carrying out the invention. The description is not to be taken in a limiting sense, but is made merely for the purpose of illustrating the general principles of the invention.

Embodiments of the invention are directed to a self-surfacing, conductive prepreg suitable for use in an automated lamination machine, such as automated fiber placement (AFP) machine. Prepreg is a fibrous reinforcement pre-impregnated/infused with a resin matrix used to manufacture composite structures. According to embodiments of the invention, a combination which combines a conductive surfacing film with a resin-impregnated fibrous reinforcement to form a self-surfacing, conductive prepreg. In one embodiment, the conductive surface film is laminated to the prepreg. In another embodiment, the conductive surface film is coated onto the prepreg. The self-surfacing, conductive prepreg can be used as the outermost surface layer of a composite structure. Self-surfacing, conductive prepregs according to embodiments of the invention simultaneously provide LS/ESD/EMI protection, significant weight savings and superior surface quality among other benefits to the resulting composite structure.

In the context of this application, a “surfacing film” is a resin-rich layer applied to composites to fill in surface imperfections, such as pinholes, surface cracks, core mark-off and other imperfections, thereby reducing labor-intensive manufacturing costs required to remove those imperfections. The resin may include additives, fillers, UV stabilizers, curing agents and/or catalysts. According to embodiments of the invention, at least one additive is a conductive constituent in particulate form, such as particles or flakes, dispersed throughout the resin of the surfacing film.

In the context of this application, a “prepreg” is a resin-impregnated fibrous reinforcement, which may be in the form of a fabric, or tape. In one method, prepregs are made by sandwiching fiber tows (bundles of small diameter fibers) between sheets of carrier paper that are coated with a resin matrix. Upon pressing the carrier paper over the fiber tows using heated rollers, the resin melts and impregnates the fibers thus forming a prepreg. The resin matrix may include, but are not limited to, materials such as standard or toughened epoxies, bismaleimides (BMI), cyanate esters, phenolics, reaction and condensation polyimides, and combinations thereof. The fibers, or “reinforcements”, may comprise, but are not limited to, materials such as Kevlar, fiberglass, quartz, carbon, graphite and specialty fibers. According to embodiments of the invention, a prepreg may have fibers comprised of carbon in the form of a tape or a fabric. The term “prepreg tow” or “slit tape” refers to an elongated prepreg strip with a narrow width, e.g. 1/16 inch to 1 inch, to be used in an automated fiber placement (AFP) system capable of dispensing and compacting prepreg tows or slit tapes directly on a molding surface (such as a mandrel surface) to form a composite part.

In the context of this application, “resin” is one or more compounds comprising thermoset and/or thermoplastic materials. Examples may include, but are not limited to, epoxies, epoxy curing agents, phenolics, phenols, cyanate esters, polyimides (e.g., bismaleimide (BMI) and polyetherimides), polyesters, benzoxazines, polybenzoxazines, polybenzoxazones, polybenzimidazoles, polybenzothiazoles, polyamides, polyamidimides, polysulphones, polyether sulphones, polycarbonates, polyethylene terephthalates, cyanates, cyanate esters; and polyether ketones (e.g. polyether ketone (PEK), polyether ether ketone (PEEK), polyether ketone ketone (PEKK) and the like), combinations thereof, and precursors thereof.

Epoxy resins may further include polyepoxides having at least about two epoxy groups per molecule. The polyepoxides may be saturated, unsaturated, cyclic, or acyclic, aliphatic, alicyclic, aromatic, or heterocyclic. Examples of suitable polyepoxides include the polyglycidyl ethers, which are prepared by reaction of epichlorohydrin or epibromohydrin with a polyphenol in the presence of alkali. Suitable polyphenols therefore are, for example, resorcinol, pyrocatechol, hydroquinone, bisphenol A (bis(4-hydroxyphenyl)-2,2-propane), bisphenol F (bis(4-hydroxyphenyl)methane), bis(4-hydroxyphenyl)-1,1-isobutane, 4,4′-dihydroxybenzophenone, bis(4-hydroxyphenyl)-1,1-ethane, and 1,5-hydroxynaphthalene. Other suitable polyphenols as the basis for the polyglycidyl ethers are the known condensation products of phenol and formaldehyde or acetaldehyde of the Novolac resin-type.

Other polyepoxides may include the polyglycidyl ethers of polyalcohols or diamines. Such polyglycidyl ethers are derived from polyalcohols, such as ethylene glycol, diethylene glycol, triethylene glycol, 1,2-propylene glycol, 1,4-butylene glycol, triethylene glycol, 1,5-pentanediol, 1,6-hexanediol or trimethylolpropane.

Other polyepoxides may include polyglycidyl esters of polycarboxylic acids, for example, reaction products of glycidol or epichlorohydrin with aliphatic or aromatic polycarboxylic acids, such as oxalic acid, succinic acid, glutaric acid, terephthalic acid or a dimeric fatty acid. Other epoxides may include those derived from the epoxidation products of olefinically-unsaturated cycloaliphatic compounds or from natural oils and fats. Other epoxides may include liquid epoxy resins derived by reaction of bisphenol A or bisphenol F and epichlorohydrin. The epoxy resins that are liquid at room temperature generally have epoxy equivalent weights of from 150 to about 480.

Epoxy resins that are solid at room temperature may also, or alternatively, be used and are likewise obtainable from polyphenols and epichlorohydrin, for example, those based on bisphenol A or bisphenol F having a melting point of from 45° C. to 130° C., preferably from 50° C. to 80° C. These differ from the liquid epoxy resins substantially by the higher molecular weight thereof, as a result of which they become solid at room temperature. The solid epoxy resins generally have an epoxy equivalent weight of greater than or equal to 400.

In the context of this application, “cure” and “curing” means a polymerizing and/or cross-linking processes. Curing may be performed by processes that include, but are not limited to, heating, exposure to ultraviolet light, and/or exposure to radiation. In certain embodiments, curing may take place within the matrix. Prior to curing, the matrix may further comprise one or more compounds that are at about room temperature, liquid, semi-solid, crystalline solids, and combinations thereof. In further embodiments, the matrix within a prepreg may be partially cured in order to exhibit a selected stickiness or tack. In certain embodiments, consolidation and curing may be performed in a single process.

In the context of this application, “consolidation” means processes in which the resin or matrix material flows so as to displace void space within and adjacent fibers. For example, “consolidation” may include, but is not limited to, flow of matrix into void spaces between and within fibers and prepregs, and the like. Consolidation may further take place under the action of one or more of heat, vacuum, and applied pressure. In certain embodiments, consolidation and curing may be performed in a single process.

Representative self-surfacing, conductive prepreg includes low fabric areal weight (FAW) of less than 100 gsm or standard FAW (100-200 gsm) unidirectional impregnated carbon tape or fabric in combination with a highly conductive epoxy resin composition layer on at least one surface thereon. According to embodiments of the invention, the highly conductive epoxy resin composition layer may be in the form of a coating or film. The conductive nature of the self-surfacing, conductive prepreg may be provided by any material (or constituent) having a conductive property including, but not limited to, metals, metal alloys, metal-coated particles, surface functionalized metals, intrinsic conductive polymers, and/or conductive carbon nano-fibers, tubes and/or strands dispersed substantially uniformly throughout or on the coating or film.

Examples of nanofibers suitable for use as conductive constituents include, but are not limited to, bare carbon nanofibers (e.g., CNF, metal-coated CNF, CF, Graphite, GO, Carbon black, and NanoBlack II (available from Columbian Chemical, Inc.); carbon nanotubes (e.g., SWCNT, DWCNT or MWCNT); and nanostrands (e.g., nickel-based, very long sub-micron diameter filaments of nickel or iron, with typical aspect ratios of 100:1 to 1000:1). Examples of intrinsic conductive polymers suitable for use as conductive constituents include, but are not limited to, polythiophene, polyaniline and polypyrrole.

Metals and their alloys may be employed as preferable conductive constituents in view of their relatively high electrical conductivity. Examples of metals and alloys may include, but are not limited to, silver, gold, nickel, copper, aluminum, and alloys and mixtures thereof. In certain embodiments, the morphology of the conductive metal additives may include one or more of flakes, powders, fibers, wires, microspheres, and nanospheres, singly or in combination. In a particular embodiment, the metal may be silver flakes present in a concentration ranging between 5 to 70 weight percent, preferably 46 to 63 weight percent, on the basis of the total weight of the composition. However, depending on the application, the amount of conductive constituent may vary significantly as known by one of ordinary skill in the art.

The highly conductive epoxy resin composition may include other constituents including, but not limited to, thermoplastic or thermosetting polymers, additives, fillers, stabilizers, curing agents and/or catalysts. Thermosetting polymers function as the base film-forming composition in addition to providing film rigidity and surface hardness to the film. Examples of thermosetting resins may include, but are not limited to, resins such as those listed previously. In some embodiments, the thermosetting resins may include one or more of epoxies, bismaleimides (BMI), cyanate esters, phenolics, benzoxazines, and polyamides. In other embodiments, the thermosetting resin may include diglycidylether of bisphenol A, diglycidylether of terabromo bisphenol A, and teraglycidylether methylenedianiline, 4-glycidyloxy-N,N′-diglycidyaniline, and combinations thereof. The thermosetting resins may further include chain extension agents and tougheners. In one embodiment, the thermosetting resins may be present in a concentration ranging between about 5 to 95 weight percent, on the basis of the total weight of the composition. In other embodiments, the thermosetting resins may be present in a concentration ranging between about 20 to 80 weight percent.

Additional thermosetting resins for adjusting the tack and drape of the composition may also be included. Embodiments of such resins may include, but are not limited to, multi-functional epoxy resins. Examples of di- and multi-functional epoxy resins may include, but are not limited to, commercially available resins such as those sold under the trade names MY 0510, MY 9655, MY 9663, Tactix 721, Epalloy 5000, MX 120, MX 156, DEN 439, DEN 438, and DER 661. The additional epoxy resins may be present in an amount ranging between about 0 to 70 weight percent on the basis of the total weight of the composition.

In some embodiments, non-conductive fillers are added to the composition. Fillers provide surfacing smoothness and surface abrasion resistance. Examples of non-conductive fillers may include ground or precipitated chalks, quartz powder, alumina, dolomite, carbon fibers, glass fibers, polymeric fibers, titanium dioxide, fused silica, carbon black, calcium oxide, calcium magnesium carbonates, barite and, especially, silicate-like fillers of the aluminum magnesium calcium silicate type. Specific examples include ceramic microspheres (e.g., ZEEOSPHERES 200™ by 3M Corp.), glass balloons (e.g., iM30K, A16, H₂O by 3M Corp.; SID-230Z-S2 by Emersion & Cummings), and fumed silica. The fillers may be solid and provided in the form of flakes, powders, fibers, microsphere, or glass balloons, and may be solid or hollow structures, as necessary. In one embodiment, the fillers may include ZEEOSPHERES 200 thick-walled spheres of a silica-alumina ceramic composition. In certain embodiments, the largest fillers may range between about 12 to 150 μm. The fillers may be further present in an amount ranging between about 0 to 40 weight percent on the basis of the total weight of the composition. In other embodiments, the fillers may be present in a concentration ranging between about 5 to 35 weight percent on the basis of the total weight of the composition.

Chain extension agents may also be added to the composition to increase the molecular weight of the composition. The concentration of the chain extension agents may range between about 1 to 30 weight percent on the basis of the total weight of the composition. Examples of chain extension agents may include bisphenol A, tetrabromo bisphenol A (TBBA), bisphenol Z, tetramethyl bisphenol A (TMBP-A), and other bisphenol fluorines, as discussed in U.S. Pat. No. 4,983,672.

Pigments may be added to the composition for adjusting the color and appearance of the surfacing film. In one embodiment, pigments may include titanium dioxide, carbon black, black pigment, and other color dyes. The pigments may be provided in the form of flakes, powders, fibers, color concentrate liquid. The total amount of all pigments may range between about 0 to 20 weight percent on the basis of the total weight of the composition.

Flow control agents may also be added to the composition. The flow control agents may be employed to modify the rheological properties of the composition. Embodiments of the flow control agents may include, but are not limited to, fumed silica, microspheres, and metallic powders. The flow control agents may be provided in the form of flakes, powders, fibers, spheres, or pellets. The largest dimension of the flow control agents may range between about 0.5 to 10 μm. The flow control agents may be present in an amount ranging between about 0 to 40 weight percent, more preferably, about 0.1 to 10 weight percent, on the basis of the total weight of the composition.

In some embodiments, UV stabilizers are added to the composition. UV stabilizers provide resistance to polymer degradation of the resultant composite structure incorporating such constituents. Examples of UV stabilizers may include UV absorbers, antioxidants, pigments, blocking agents, and fillers. Specific examples include, but are not limited to, butylated hydroxytoluene (BHT), 2-hydroxy-4-methoxy-benzophenone (UV-9),2,4-Bis(2,4-dimethylphenyl)-6-(2-hydroxy-4-octyloxyphenyl)-1,3,5-triazine (Cyasorb™ UV-1164 light absorber), 3,5-Di-tert-butyl-4-hydroxybenzoic acid, n-hexadecyl ester (Cyasorb™ UV-2908 light stabilizer), titanium dioxide, and carbon black. The UV stabilizers may be provided in the form of solid or liquid. In an embodiment, the UV stabilizers may each be present in an amount ranging between about 0.1 to 5 weight percent on the basis of the total weight of the composition. In other embodiments, the UV stabilizers may each be present in an amount ranging between about 0.5 to 3 weight percent on the basis of the total weight of the composition.

In some embodiments, curing agents and/or catalysts are added to the composition. Examples of curing agents and catalysts may include, but are not limited to, aliphatic and aromatic primary amines, aliphatic and aromatic tertiary amines, boron trifluoride complexes, guanidines, and dicyandiamide. Additional examples of curing agents and catalysts may be found in U.S. Pat. No. 4,980,234 and U.S. Patent Application Publication No. 2008/0188609. Further examples of amine curing agents and catalysts may include, but are not limited to, dicyandiamide, bisureas (e.g., 2,4-Toluene bis-(dimethyl urea), (i.e., Omicure™ U-24 or CA 150 available from CVC Thermoset Specialties), 4,4′-Methylene bis-(phenyl dimethylurea), (i.e., Omicure™ U-52, or CA 152 available from CVC Thermoset Specialties), and 4,4′-diaminodiphenyl sulfone (4,4-DDS), and BF₃. One or more curing agents may be present in an amount ranging between about 0.1 to 40 weight percent, preferably, about 0.5 to 10 weight percent on the basis of the total weight of the composition.

The composition comprising the conductive surfacing films according to embodiments of the invention is generally prepared by weighing the required quantities of constituents including various epoxy resins (with or without solvent), conductive constituents, fillers, pigments, UV stabilizers, flow control agents and other constituents into a mixing vessel equipped for heating and cooling. The mixture is then stirred without heating using a high speed shear mixer until thoroughly homogeneous.

The temperature during the mixing should be maintained below 130° F. to reduce solvent evaporation. The temperature can rise during the shearing of conductive ingredients, tillers, pigments and flow, control agents, and the loss of solvent can be replaced by adding more solvent. After the dispersion of fillers, pigments, and flow control agents, the surfacing film composition is cooled to below 130° F. and the latent amine based epoxy curing agents and amine catalysts are added and dispersed without shearing. The temperature during this dispersion is kept below 130° F. to prevent resin advancement by prematurely initiating the catalyst decomposition and reaction with the epoxy resins.

After the dispersion of latent amine based epoxy curing agents and amine catalysts, the completed surfacing film composition is dried under vacuum to remove solvent as necessary to adjust the solids content for film coating. The desired surfacing film composition is then coated as a film on a silicone backed or other suitable release paper and dried to below about 1% solvent level.

According to embodiments of the invention, fibrous reinforcements such as resin-impregnated carbon fabrics or tapes may provide a substrate in which the highly conductive epoxy resin composition layer may be applied. In some embodiments, the carbon fibers in the fibrous reinforcement may be bidirectional or unidirectional, preferably unidirectional. In some embodiments, the carbon fabrics may have a plain, twill, harness satin, or crow-foot satin weave, preferably a plain weave. In some embodiments, the carbon fabric or tape should have a FAW of between about 25 grams per square meter (gsm) and about 250 gsm. In some embodiments, the carbon fabric or tape should comprise between about 1000 filaments and about 6000 filaments, in one embodiment about 3000 filaments. Representative examples of carbon fabric or tapes which may be used include, but are not limited to, Cycom™ 997/M40J UD tape, Cyclo™ 970/IM4 UD tape, Cycom™ 5276-1, Cycom™ 934, Cycom™ 977-2 or 977-3, Cycom™ 970, Cycom™ 5320/5320-1, Toray 3900-2, Cycom™ 5317, Hexply M21, Hexply 8552 prepreg, Cycom™ 5250-4, BMS 8-276 prepreg, BMS 8-256 prepreg. The carbon fabrics or tapes may be impregnated with any number of epoxy resin combinations such as MY510, DER 331, MY 721 and MY 600.

According to embodiments of the invention, self-surfacing, conductive prepreg may be manufactured by consolidating a highly conductive epoxy resin composition layer, e.g., conductive surfacing film, onto at least one surface of carbon fabric or tape. The highly conductive epoxy resin composition layer may be between about 0.020 pounds per square foot (psf) to 0.060 psf of the carbon fabric or tape (preferably weight between 0.025 psf and 0.045 psf); however, depending on the application, the weight or thickness of the layer may vary significantly as known by one of ordinary skill in the art. In some embodiments, carbon fabric or tape may be sandwiched between two highly conductive epoxy resin composition layers at a temperature of between 110° F. and 140° F. for between about 0.2 hours and 1 hour in an Autoclave at a pressure of between about 14 pounds per square inch (psi) and 85 psi. The resulting self-surfacing, conductive prepreg combination may be used to manufacture composite structures.

According to some embodiments of the invention, the self-surfacing, conductive prepreg may be applied as a surface layer by hand lay-up or automated lamination processes to form a composite structure or a prepreg layup composed of a plurality prepreg plies. The plies can number between 1 and 1000 plies depending on the application, more narrowly between about 8 and 50 plies. The plies may be oriented according to a ply schedule, or stacking sequence, appropriate for the application. Representative examples of plies which may be used according to embodiments of the invention include, but are not limited to, Cycom™ 5276-1, Cycom™ 934, Cycom™ 970, Cycom™ 977-2, Cycom™ 5320-1, Cycom™ 5317, and Toray 3900-2.

The self-surfacing, conductive prepreg as disclosed herein is well suited for automated fiber placement (AFP), as slit tape or prepreg tow of various widths (typically, 1/16 inch to 1 inch) suitable for automation placement. AFP automatically places multiple individual pre-impregnated prepreg tows directly onto a mandrel or mold surface at high speed, using one or more numerically controlled placement heads to dispense, clamp, cut and restart each tow during placement. One or more tows are dispensed side by side onto the mandrel surface to create a layer of a desired width and length, and then additional layers are built up onto a prior layer to provide a layup with a desired thickness. Minimum cut length (the shortest tow length a machine can lay down) is the essential ply-shape determinant. The fiber placement head can be attached to an existing gantry system, retrofitted to a filament winding machine or delivered as a turnkey custom system. Such AFP system is conventionally used for the manufacturing of large composite aerospace structures, such as fuselage sections or wing skins of aircrafts. By incorporating the self-surfacing prepreg tow in the AFP process, a lighter composite part with a conductive surface can be fabricated as compared to the conventional method of applying a metal foil or sheet in the layup process to provide a conductive surface. Furthermore, using the self-surfacing prepreg tow in AFP process is more efficient because this eliminates some of the intermediate processing steps that are typical in the conventional methods of applying surfacing films onto an existing prepreg layup.

Following laying-up of the prepreg plies or tows, the preprg layup may be co-cured in an Autoclave or similar device resulting in a composite structure with a conductive surface. In some embodiments, co-curing may be at a temperature of between 200° F. and 375° F. for between about 1 hour and 8 hours at a pressure of between about 40 pounds psi and 85 psi. The cure cycle may employ a ramp-up, dwell or combination procedure thereof as known by one of ordinary skill in the art.

According to embodiments of the invention, a paint appropriate for a composite structure may be applied to the cured composite structure. In some embodiments, a paint thickness (i.e., the sum of primer and paint) of between about 2 Mil (i.e., 50 microns) and 5 Mil (i.e., 125 microns) may be applied to the conductive surface of the composite structure. This paint thickness range may be appropriate for aerospace applications. In other embodiments, a paint thickness (i.e., the sum of paint primer and top-coat paint) of between about 8 Mil (i.e., 200 microns) and 13 Mil (i.e., 325 microns) may be applied to the conductive surface of the composite structure. This paint thickness range may be appropriate for painting the airplane composite parts. The paint typically is not electrically conductive. It provides the desired exterior appearance and a barrier for the airplane structural parts.

Composite structures manufactured using self-surfacing, conductive prepregs according to embodiments of the invention have numerous advantages over conventional methods of fabricating composite structures including, but not limited to: electrical conductivity suitable for lightning strike protection (LSP) and electromagnetic energy (EME) events; damage resistance to lightning strikes; a high degree of conductivity while realizing significant weight savings; UV stability; superior surface quality; superior paint stripper resistance; and increased microcrack resistance.

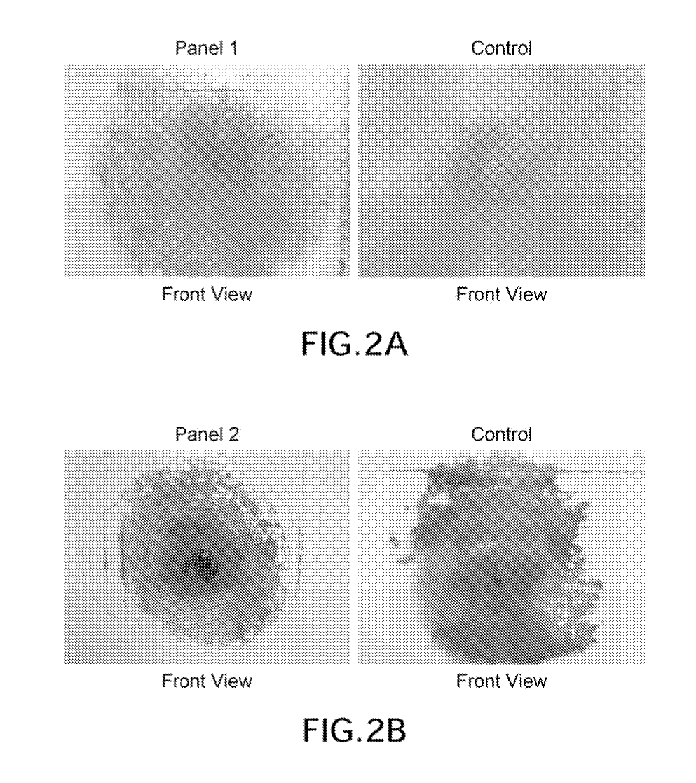

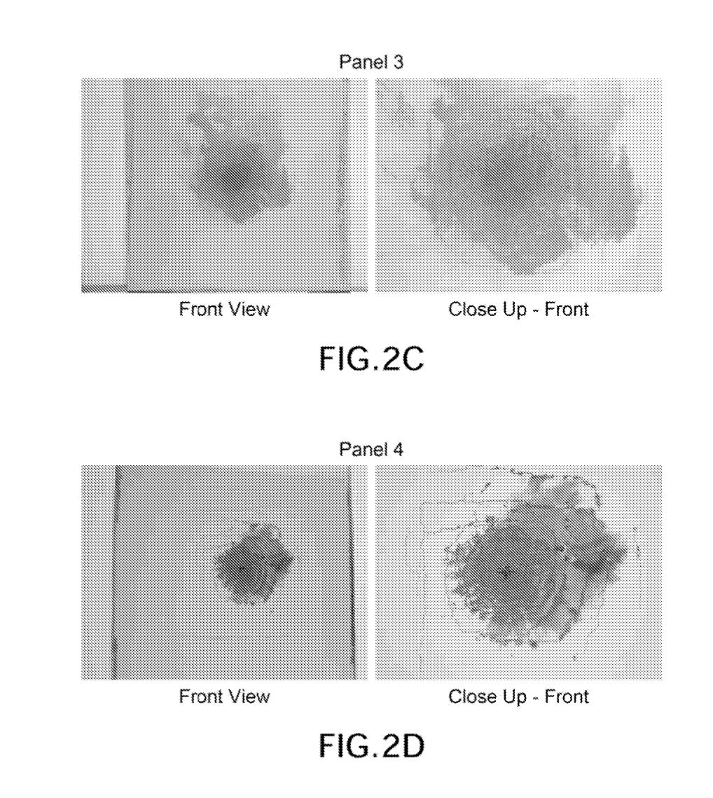

As a result of an actual fatal plane crash caused by a lightning strike, the Federal Aviation Administration (FAA) implemented a system to categorize various zones for commercial aircraft based on probability and severity of being struck by lightning. The areas of concern are categorized as Zones 1A-1C, 2A-2B and 3, with Zone 1A (200,000 amps) being the most crucial with respect to withstanding a lightning strike. Lightning strike test results of composite structures manufactured using self-surfacing, conductive prepregs according to embodiments of the invention have shown good performance in Zone 2A and 1A testing. Good performance in Zone 2A and 1A means minimum surface or structure damage, i.e., the surface is repairable and there is no punch-through hole after a lightning strike (See FIGS. 2A-2D).

The outermost layer of composite structures manufactured using self-surfacing conductive prepregs according to embodiments of the invention provide high surface conductivity (i.e., less than 100 mΩ) in X-, Y-, and Z directions, a key to enable good LSP characteristic. More particularly, the composite structures exhibited conductivity in a range of between about 1 to 60 mΩ, more narrowly between about 10 to 30 nΩ. In preferred embodiments, the surface conductivity is less than 60 mΩ Generally, the lower the resistivity, the higher the electrical conductivity. High surface conductivity results in substantial electrical current dissipation which results in damage resistance of the composite structure.

The self-surfacing conductive prepreg layer provides significant weight savings (up to 50% plus) by eliminating metal screens (or IWWF layer) and the surfacing film layer, that also greatly facilitates the structural design flexibility and productivity improvement through AFP automation.

In addition to evidencing sufficient LSP, it is anticipated that the composite structures manufactured using self-surfacing, conductive prepregs according to embodiments of the invention will protect from other potentially harmful electrical events such as electrostatic discharge (ESD), static charge build-up, electromagnetic interference (EMI), wing edge glow potential, current return network (CRN) and high intensity related fields (HIRF). Experimental testing showed that composite structures manufactured using self-surfacing, conductive prepregs according to embodiments of the invention showed shielding effectiveness (SE) values of between 38 and 50 dB within 8 to 12 GHz frequency, which is similar to aluminum metal but without the added weight of aluminum sheet metal or metal screen surface panels.

Polymers and polymer mixture are known to degrade when exposed to UV radiation. A polymer composition's ability to resist UV degradation is referred to as the composition's UV stability. The “UV stability” of the material can be measured quantitatively by monitoring property changes of the composite structure before and after UV exposure following different UV exposure time periods. For example, the property of paint adhesion after UV exposure may be used as a measure for UV stability (e.g., scribed paint adhesion test, or rain erosion test). Composite structures manufactured using self-surfacing, conductive prepregs according to embodiments of the invention exhibited superior UV resistance (i.e., good UV stability) relative to composite structures manufactured using conventional surfacing films.

Composite structures are generally painted. “Paint stripper resistance” is a measure of the composite structure's ability to resist stripping caused by paint stripper fluid attack (e.g., Cee-Bee E-2010A available from McGean and Turco 1270-6 available from Henkel) during paint removal process. Paint stripper resistance can be measured quantitatively by property changes before and after paint stripper immersion after different time periods. For example, paint stripper fluid pick-up (weight percent), surface appearance and surface hardness change are properties that can be used to measure paint stripper resistance. Composite structures manufactured using self-surfacing, conductive prepregs according to embodiments of the invention exhibited good paint stripper resistance relative to composite structures manufactured using conventional surfacing films. This has been demonstrated by the hardness retention and minimal fluid uptake and unchanged surface appearance composite laminate panels comprised of self-surfacing conductive prepreg according to embodiments of the invention, upon the panel immersion in paint stripper fluid up to 168 hours.

“Surface quality” of a composite structure is a measure of the degree in which the surface of a composite structure is defect-free, i.e., lack of surface pits, pinholes and/or cracks. Good surface quality should exhibit a substantially uniform appearance and should be “paint-ready”, i.e., no sanding preparation needed (in contrast to required surface coating for composite structures exhibiting poor surface quality). Composite structures manufactured using self-surfacing, conductive prepregs according to embodiments of the invention exhibited defects-free “paint ready” surface quality relative to composite structures manufactured using conventional surfacing films.

Microcrack resistance is the ability of a material to resist formation of small, numerous cracks upon a damage event that eventually weakens and compromises the composite article. Microcrack resistance can be evaluated by measuring the toughness (G_{IC}) and/or fracture toughness (K_{IC}) of the material. More particularly, microcrack resistance referenced herewith is the resistance of the composite structure to surface paint-cracking and the cracking of the structure underneath. Composite structures manufactured using self-surfacing, conductive prepregs according to embodiments of the invention exhibited good microcrack resistance (after thermal cycling between −55° C. and 71° C. for 2000 cycles) relative to composite structures manufactured using conventional surfacing films due to the intrinsic resistance of the self-surfacing, conductive prepreg to microcracks on the paint surface and/or through the composite structure underneath.

Component parts fabricated with self-surfacing, conductive prepregs according to embodiments of the invention may be used in the manufacture of any aerospace component including those on commercial, military, business or regional jet, rotorcraft and jet engines that require the composite to have conductive properties. These would include, aircraft structure in FAA-defined lightning strike areas (Zones 1A-1C, 2A-2B, 3), e.g., wings, fuselages; and aircraft structure requiring protection from potentially harmful electrical events such as electrostatic discharge (ESD), static charge build-up, electromagnetic interference (EMI), wing edge glow potential, current return network (CRN) and high intensity related fields (HIRF).

### Example 1

An experiment was conducted to measure the LSP of composite structures manufactured using self-surfacing, conductive prepregs according to embodiments of the invention.

Composition. The composition used to formulate the highly conductive epoxy resin composition layer, i.e., modified conductive surfacing film, was prepared according to the following formulation. For each type of film, a four-film lamination process was used.

TABLE 1

| Component | Weight % |
|---|---|
| Epoxy Resins | 166 |
| Conductive agent | 300 |
| UV stabilizers | 10 |
| Fillers | 50 |
| Curing agents | 5 |
| Flow Control | 10 |
| TOTAL | 541 |

Composition preparation. (1) Weigh required amount of pre-react epoxy based on the solids. Add additional epoxies. Add solvent (as needed) to the mix to get the mix stirring under Cowles stirrer. Stir for 10-15 minutes. (2) Slowly add the conductive ingredient, flow control agent and filler to the mix under Cowles. Add additional solvent to the mix as necessary to keep the mix from climbing the shaft. When all the conductive ingredient, flow control agent, and fillers have been added, continue to shear the mix for another 50-70 minutes. Keep the mix temperature below 130° F. (3) Add UV stabilizers. Add solvent (as needed) to the mix to get the mix stirring under Cowles stirrer. Stir for 5-10 minutes. (4) Cool the mix below 120° F. and add curing agent. Mix for 5-10 minutes until homogeneous. Make sure mix temperature stays below 130° F. while mixing in the curing agents. (5) Strain mix through EP-15, and de-aired under vacuum to about 80% solids for lab coating trials.

Conductive self-surfacing prepreg preparation. Laminate the modified conductive surfacing film (˜0.030 psf) with a low FAW CF fabric film (e.g., a 95 gsm Cycom™ 997-M40J uni-tape) or a standard FAW composite prepreg uni-tape (e.g., 190 gsm Cycom™ 5275-1 UD tape or BMS 8-276 prepreg) by consolidation at 130° F. for 0.5 hour in Autoclave at 50 psi pressure.

Composite incorporating conductive self-surfacing prepreg preparation. Prepare a 9-ply lay-up of Cycom™ 5276-1 (prepreg) with a stacking sequence [+45, 0, −45, 90, 0, 90, −45, 0, +45] on a smooth plate tool with release agent (i.e., Frekote™) with a conductive self-surfacing prepreg (i.e., a 95 gsm Cycom™ 997-M40J uni-tape) prepared as described previously positioned as the outermost layer. Co-cure with an autoclave cycle with dwell time of 2 hours at 350° F. and 80 psi pressure. The prepared composite laminate panels (˜24″×24″) can be painted per aerospace paint specification before lightning strike test (Zone 2A or 1A).

Results. Self-surfacing, conductive prepreg panels manufactured according to the procedure outlined previously were tested in lightning strike Zones 2A and 1A with normal paint thickness (3 to 4 Mils). The self-surfacing, conductive prepreg showed excellent surface appearance along with good electrical conductivity (surface resistivity less than 50 milliohm). The panels passed the LS Zone 1A and 2A tests.

While certain exemplary embodiments have been described and shown in the accompanying drawings, it is to be understood that such embodiments are merely illustrative of and not restrictive on the broad invention, and that this invention is not to be limited to the specific constructions and arrangements shown and described, since various other modifications may occur to those ordinarily skilled in the art.

What is claimed is:

1. A method of fabricating a composite structure having a conductive surface, said method comprising:
forming a self-surfacing, conductive prepreg in the form of an elongated tape, said self-surfacing, conductive prepreg comprised of a conductive surfacing film formed on a curable prepreg ply by a lamination or coating process, said conductive surfacing film comprising a conductive constituent in particulate form dispersed throughout a resin matrix and having a conductivity of less than 20 milliOhms;
incorporating the self-surfacing, conductive prepreg in an Automated Fiber Placement (AFP) process to form a curable prepreg layup comprised of a plurality of prepreg tapes arranged in a stacking sequence with the conductive surfacing film positioned as an outermost layer, said AFP process comprising laying up prepreg tapes using an AFP system equipped with means for dispensing and compacting prepreg tapes directly on a molding surface for forming a composite part; and
curing the prepreg layup.

2. The method of claim 1, wherein the surfacing film comprises a plurality of epoxy resins and further comprises at least one UV stabilizer, and wherein and the conductive additives are present in an amount between 46 and 63 weight percent of the surfacing film.

3. The method of claim 1 wherein the surfacing film has a thickness of between 0.020 pounds per square foot and 0.045 pounds per square foot.

4. The method of claim 1 wherein the prepreg ply for forming the self-surfacing, conductive prepreg comprises one of a low fabric areal weight of less than 100 gsm or standard fabric areal weight unidirectional carbon tape or fabric which is infused with one or more epoxy resins.

5. The method of claim 1, wherein the conductive constituent is in the form of metallic flakes or powder and is present in an amount sufficient to provide electrical conductivity suitable for lightning strike protection (LSP).

6. A method of fabricating a composite structure having a conductive surface, comprising:
forming a first conductive epoxy resin layer onto a first surface of a curable prepreg ply, said prepreg ply comprising fibrous reinforcement infused with a resin matrix;
forming a second conductive epoxy resin layer onto a second surface of said curable prepreg ply, wherein the first and second conductive epoxy resin layers have a conductivity of less than 20 milliOhms and comprise conductive additives in particulate form dispersed throughout a resin matrix, whereby the combination of the curable prepreg ply and the conductive epoxy resin layers forms a self-surfacing, conductive prepreg;
laminating the self-surfacing, conductive prepreg to one or more curable prepreg plies, in a stacking sequence, to form a prepreg layup with the self-surfacing, conductive prepreg positioned as an outermost layer thereof; and
curing the prepreg layup, thereby forming a composite structure having a conductive surface.

7. The method of claim 6 wherein each of the first and second epoxy resin layers comprises a plurality of epoxy resins and at least one UV stabilizer, and the conductive constituent is present in an amount between 46 and 63 weight percent of each epoxy resin layer.

8. The method of claim 6 wherein each epoxy resin layer forms a surfacing film, the surfacing film having a thickness of between 0.020 pounds per square foot and 0.045 pounds per square foot.

9. The method of claim 6 wherein the prepreg ply for forming the self-surfacing, conductive prepreg comprises one of a low fabric areal weight of less than 100 gsm or standard fabric areal weight unidirectional carbon tape or fabric which is infused with one or more epoxy resins.

10. The method of claim 6 further comprising applying a paint to the composite structure at a thickness of between 3 and 13 Mil.

11. The method of claim 6 wherein said laminating to form a prepreg layup is carried out by an Automated Fiber Placement (AFP) system equipped with means for dispensing and compacting prepreg tapes directly on a molding surface for forming a composite part.

12. A composite structure having a conductive surfacing film made by the method of claim 6.

13. A painted composite structure made by the method of claim 10.
